(19) United States
(12) Patent Application Publication
(10) Pub. No.: US 2026/0145230 A1
(43) Pub. Date: May 28, 2026

(54) Method For Manufacturing Metal Shaped Article And Metal Shaped Article

(71) Applicant: SEIKO EPSON CORPORATION, Tokyo (JP)

(72) Inventors: Keisuke ITOTSUBO, Hachinohe (JP); Keisuke AIDA, Hachinohe (JP)

(21) Appl. No.: 19/400,829

(22) Filed: Nov. 25, 2025

(30) Foreign Application Priority Data
Nov. 26, 2024 (JP) 2024-205301

(51) Int. Cl. B22F 1/052; B22F 1/06; B22F 10/14; B22F 10/28; B22F 12/63; B33Y 10/00; B33Y 30/00; B33Y 80/00

(52) U.S. Cl. CPC B22F 1/052; B22F 1/06; B22F 10/14; B22F 10/28; B22F 12/63; B33Y 10/00; B33Y 30/00; B33Y 80/00; B22F 2304/10

(57) ABSTRACT

A method for manufacturing a metal shaped article by bonding particles of metal powder contained in a powder layer to each other includes: forming a powder layer by leveling, with a squeegee roller, metal powder that has an average circularity of 0.80 or more and less than 1.00, a specific surface area of 0.30 m²/g or less, a particle diameter D50, at which the cumulative frequency from the small diameter side is 50% in a cumulative particle size distribution, of 1.0 μm or more and 10.0 μm or less, and a particle diameter D90, at which the cumulative frequency from the small diameter side is in the cumulative particle size distribution, of 11.0 μm or more and 25.0 μm or less; and bonding the particles of the powder contained in the powder layer to each other; wherein the rotation speed of the squeegee roller is set to 0 rpm or more and 50 rpm or less, and the moving speed of the squeegee roller is set to 1 mm/s or more and 25 mm/s or less.

The present application is based on, and claims priority from JP Application Serial Number 2024-205301, filed Nov. 26, 2024, the disclosure of which is hereby incorporated by reference herein in its entirety.

### BACKGROUND

### 1. Technical Field

The present disclosure relates to a method for manufacturing a metal shaped article and a metal shaped article.

### 2. Related Art

As a technique for shaping a three-dimensional object, an additive manufacturing method using a metal powder is widely used in recent years. Among these, a powder bed fusion method and a binder jet method include forming a powder layer, and forming a three-dimensional powder shaped article by melting or binding the particles to each other in a part of the powder layer. The powder shaped article formed by binding the particles to each other is then subjected to sintering treatment, resulting in a metal shaped article (metal sintered body).

For example, JP-A-2020-142420 discloses a method for manufacturing a powder shaped article that repeatedly includes forming a powder layer, applying a liquid to the powder layer based on the shape data of a three-dimensional model, and drying the powder layer to which the liquid is applied. In addition, JP-A-2020-142420 discloses that the quality of the powder shaped article can be stabilized by controlling the liquid application operation according to the drying state of the powder layer. By stabilizing the quality of the powder shaped article in this way, the quality of the metal shaped article obtained by sintering the powder shaped article can finally be stabilized.

JP-A-2020-142420 is an example of the related art.

In the method for manufacturing a metal shaped article as described above, the fillability of the metal powder in the powder layer affects the density and dimensional accuracy of the metal shaped article finally obtained. However, JP-A-2020-142420 does not sufficiently disclose a method for enhancing the fillability of the powder layer.

For example, JP-A-2020-142420 discloses increasing the space filling ratio of the powder layer by using a plurality of types of powders having different average particle diameters. However, even when the plurality of types of powders are used, it is difficult to sufficiently increase the space filling ratio of the powder layer depending on the forming method of the powder layer. When there is a region with a low space filling ratio, the density and dimensional accuracy of the metal shaped article finally obtained decrease, and its homogeneity is impaired.

Therefore, there is a demand for a manufacturing method that can manufacture a homogeneous metal shaped article having high density and dimensional accuracy, and that can efficiently manufacture such metal shaped articles.

### SUMMARY

A method for manufacturing a metal shaped article according to an application example of the present disclosure is a method for manufacturing a metal shaped article by bonding particles of metal powder contained in a powder layer to each other, the method including: forming the powder layer by leveling, with a squeegee roller, the metal powder that has an average circularity of 0.80 or more and less than 1.00, a specific surface area of 0.30 m²/g or less, a particle diameter D50, at which the cumulative frequency is 50% from the small diameter side, in a cumulative particle size distribution on a volume basis obtained by using a laser diffraction type particle size distribution measuring apparatus, of 1.0 μm or more and 10.0 μm or less, and a particle diameter D90, at which the cumulative frequency is 90% from the small diameter side, in the cumulative particle size distribution of 11.0 μm or more and 25.0 μm or less; and bonding the particles of the powder contained in the powder layer to each other; wherein the rotation speed of the squeegee roller is set to 0 rpm or more and 50 rpm or less, and the moving speed of the squeegee roller is set to 1 mm/s or more and 25 mm/s or less.

A metal shaped article according to an application example of the present disclosure is a metal shaped article shaped by stacking a molten material or a sintered body of the particles with each other in a stacking direction in a powder layer containing metal powder, wherein
in a cross section obtained by cutting along a plane including the normal to the powder layer,
a region having a width of 10 μm in an extending direction of the normal and a length of 700 μm in a direction orthogonal to the normal is defined as one analysis range,
a total of 10 analysis ranges are set while shifting the region by 10 μm each in a depth direction, an occupied area and an occupied area ratio of the molten material or the sintered body are calculated at each of the analysis ranges, and
calculation is performed by a calculation formula| (ratio of the occupied areas in the analysis ranges adjacent to each other)−1| at the analysis ranges adjacent to each other to obtain calculation results, and when the calculation results are obtained,
the occupied area ratios in the 10 analysis ranges are all 90.0% or more, and an average value of the calculation results determined from the 10 analysis ranges is 0.050 or less.

### BRIEF DESCRIPTION OF THE DRAWINGS

FIG. 1 is a process drawing illustrating a method for manufacturing a metal shaped article according to a first embodiment.

FIG. 2 is a diagram illustrating the method for manufacturing the metal shaped article illustrated in FIG. 1.

FIG. 3 is a diagram illustrating the method for manufacturing the metal shaped article illustrated in FIG. 1.

FIG. 4 is a diagram illustrating the method for manufacturing the metal shaped article illustrated in FIG. 1.

FIG. 5 is a diagram illustrating the method for manufacturing the metal shaped article illustrated in FIG. 1.

FIG. 6 is a diagram illustrating the method for manufacturing the metal shaped article illustrated in FIG. 1.

FIG. 7 is a diagram illustrating the method for manufacturing the metal shaped article illustrated in FIG. 1.

FIG. 8 is a diagram illustrating the method for manufacturing the metal shaped article illustrated in FIG. 1.

FIG. 9 is a diagram illustrating the method for manufacturing the metal shaped article illustrated in FIG. 1.

FIG. 10 is a diagram illustrating the method for manufacturing the metal shaped article illustrated in FIG. 1.

FIG. 11 is a diagram illustrating the method for manufacturing the metal shaped article illustrated in FIG. 1.

FIG. 12 is a schematic diagram illustrating 10 analysis ranges AN1 to AN10 set in the cross section obtained by cutting the metal shaped article according to the embodiment along a plane including the normal to the powder layer.

FIG. 13 is a process drawing illustrating a method for manufacturing a metal shaped article according to a second embodiment.

FIG. 14 is Table 1 showing steel types of the additive manufacturing powders of respective sample Nos.

FIG. 15 shows Table 2 indicating the configurations of the additive manufacturing powders, the configurations of the manufacturing methods of the metal shaped articles, and the evaluation results of respective sample Nos.

FIG. 16 shows Table 3 indicating the configurations of the additive manufacturing powders, the configurations of the manufacturing methods of the metal shaped articles, and the evaluation results of respective sample Nos.

FIG. 17 shows Table 4 indicating the configurations of the additive manufacturing powders, the configurations of the manufacturing methods of the metal shaped articles, and the evaluation results of respective sample Nos.

FIG. 18 shows Table 5 indicating the configurations of the additive manufacturing powders, the configurations of the manufacturing methods of the metal shaped articles, and the evaluation results of respective sample Nos.

FIG. 19 shows Table 6 indicating the sample Nos. of additive manufacturing powders used for manufacturing the metal shaped articles, the configurations of the metal shaped articles, and the evaluation results of the metal shaped articles.

### DESCRIPTION OF EMBODIMENTS

Hereinafter, a method for manufacturing a metal shaped article and a metal shaped article according to the present disclosure will be described in detail based on embodiments illustrated in the accompanying drawings.

### 1. First Embodiment

First, a method for manufacturing a metal shaped article according to a first embodiment will be described.

### 1.1. Method for Manufacturing Metal Shaped Article

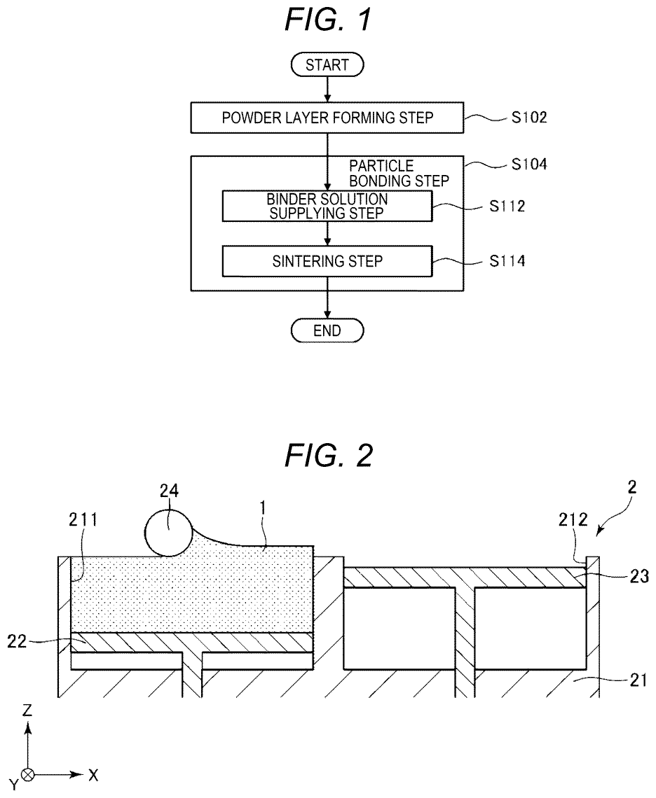

FIG. 1 is a process drawing illustrating a method of manufacturing a metal shaped article according to the first embodiment. FIGS. 2 to 11 each illustrate the method for manufacturing the metal shaped article as shown in FIG. 1. In FIGS. 2 to 11 of the present application, three axes orthogonal to each other are set as an X-axis, a Y-axis, and a Z-axis. Each axis is indicated by an arrow, and a tip side thereof is referred to as a “plus side” whereas a base side thereof is referred to as a “minus side”. In the following description, in particular, a plus side of the Z-axis is referred to as “upper”, and a minus side of the Z-axis is referred to as “lower”. In addition, both directions parallel to the X-axis are referred to as an X-axis direction, both directions parallel to the Y-axis are referred to as a Y-axis direction, and both directions parallel to the Z-axis are referred to as a Z-axis direction.

The method for manufacturing a metal shaped article illustrated in FIGS. 1 to 11 includes a binder jet method, which is a type of additive manufacturing method, and includes a powder layer forming step S102 and a particle bonding step S104. The binder jet method does not need any support structure for supporting a modeled object, and thus has an advantage that an additively manufactured body having a complicated shape can be prepared.

In the powder layer forming step S102, an additive manufacturing powder 1 (metal powder) is leveled by a squeegee roller 24 to form the powder layer 31. As the additive manufacturing powder 1, a metal powder is used which has an average circularity of 0.80 or more and less than 1.00, a specific surface area of 0.30 m²/g or less, a particle diameter D50 of 1.0 μm or more and 10.0 μm or less, and a particle diameter D90 of 11.0 μm or more and 25.0 μm or less. The particle diameter D50 refers to a particle diameter when a cumulative frequency is 50% from the small diameter side in a cumulative particle size distribution on a volume basis of the additive manufacturing powder 1 obtained using a laser diffraction type particle size distribution measuring apparatus. The particle diameter D90 refers to a particle diameter when a cumulative frequency is 90% from the small diameter side in the cumulative particle size distribution. The rotation speed of the squeegee roller 24 is set to 0 rpm or more and 50 rpm or less, and the moving speed of the squeegee roller 24 is set to 1 mm/s or more and 25 mm/s or less.

The particle bonding step S104 includes a binder solution supplying step S112 and a sintering step S114. In the binder solution supplying step S112, a binder solution 4 is supplied to a predetermined area of the powder layer 31 to bind particles in the powder layer 31 to each other and obtain a binder layer 41. The powder layer forming step S102 and the binder solution supplying step S112 are repeated once or more to obtain a powder shaped article 6 illustrated in FIG. 10. In the sintering step S114, the particles of the additive manufacturing powder 1 contained in the powder shaped article 6 are sintered (bonded) to each other.

According to such a configuration, since the powder layer 31 can be sufficiently densified, the powder shaped article 6 can be highly densified and homogenized. Therefore, by utilizing the sintering of the particles to each other in the powder layer 31, the shrinkage ratio when sintering the powder shaped article 6 can be reduced, and the shrinkage amount can be equalized. As a result, the metal shaped article 10 made of a homogeneous sintered layer having high density and high dimensional accuracy can be obtained. Hereinafter, each step will be sequentially described.

In the method for manufacturing the metal shaped article according to the first embodiment, the powder shaped article 6 is prepared by the binder jet method, but the method for manufacturing the metal shaped article according to the present disclosure may include a step of manufacturing the powder shaped article 6 by other methods. Examples of methods other than the binder jet method include fused deposition modeling (FDM). In this case, since the filament containing the metal powder and the binder is used, the powder layer forming step S102 and the binder solution supplying step S112 described above can be performed in one step.

### 1.1.1. Additive Manufacturing Apparatus

First, an additive manufacturing apparatus 2 used for manufacturing the powder shaped article 6 by the binder jet method will be described.

As illustrated in FIGS. 2 to 10, the additive manufacturing apparatus 2 includes an apparatus main body 21 including a powder storage unit 211 and a modeling unit 212, a powder supply elevator 22 provided at the powder storage unit 211, a modeling stage 23 provided at the modeling unit 212, and a squeegee roller 24 and a liquid supply unit 26 which are movably provided on the device main body 21.

The powder storage unit 211 is a recessed portion provided in the apparatus main body 21 and having an open upper portion. The additive manufacturing powder 1 is stored in the powder storage unit 211. An appropriate amount of the additive manufacturing powder 1 stored in the powder storage unit 211 is supplied to the modeling unit 212 by the squeegee roller 24. In the additive manufacturing powder 1, a metal powder is used which has the average circularity, the specific surface area, the particle diameter D50, and the particle diameter D90, each within the above ranges as described above.

The powder supply elevator 22 is disposed at a bottom portion of the powder storage unit 211. The powder supply elevator 22 is movable in an upper-lower direction in a state in which the additive manufacturing powder 1 is placed thereon. By moving the powder supply elevator 22 upward, the additive manufacturing powder 1 placed on the powder supply elevator 22 is pushed up to protrude from the powder storage unit 211. Accordingly, a protruded part of the additive manufacturing powder 1 can be moved toward the modeling unit 212.

The manufacturing unit 212 is a recessed portion provided in the apparatus main body 21 and having an open upper portion. The modeling stage 23 is disposed inside the modeling unit 212. On the modeling stage 23, the additive manufacturing powder 1 is spread in layers by the squeegee roller 24. The modeling stage 23 is movable in the upper-lower direction in a state in which the additive manufacturing powder 1 is spread thereon. By appropriately setting a height of the modeling stage 23, an amount of the additive manufacturing powder 1 spread on the modeling stage 23 can be adjusted.

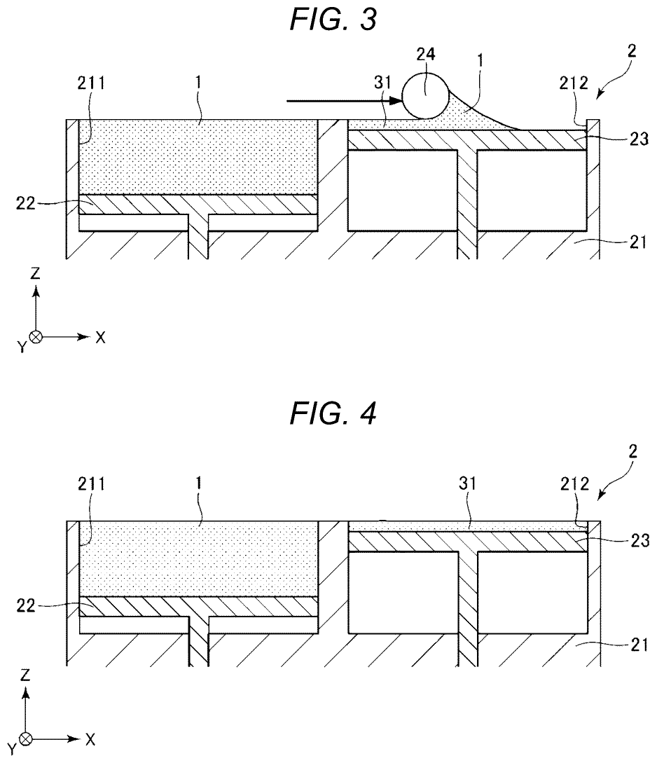

As illustrated in FIGS. 3 and 4, the squeegee roller 24 is movable in the X-axis direction from the powder storage unit 211 to the modeling unit 212. The squeegee roller 24 can level, spread, and compress the additive manufacturing powder 1 in a layered manner by dragging the additive manufacturing powder 1.

The liquid supply unit 26 is configured with, for example, an inkjet head and a dispenser, and is movable in the X-axis direction and the Y-axis direction at the modeling unit 212. The liquid supply unit 26 can supply an intended amount of the binder solution 4 to an intended position. The liquid supply unit 26 may include a plurality of ejection nozzles at one head. The binder solution 4 may be ejected simultaneously or with a time difference from the plurality of ejection nozzles.

### 1.1.2. Powder Layer Forming Step

Next, the powder layer forming step S102 using the additive manufacturing apparatus 2 will be described. In the powder layer forming step S102, the additive manufacturing powder 1 is spread on the modeling stage 23 to form the powder layer 31. Specifically, as illustrated in FIGS. 2 and 3, using the squeegee roller 24, the additive manufacturing powder 1 stored in the powder storage unit 211 is dragged onto and leveled on the modeling stage 23 to have a uniform thickness. Accordingly, the powder layer 31 shown in FIG. 4 is obtained. At this time, a thickness of the powder layer 31 can be adjusted by lowering an upper surface of the modeling stage 23 below an upper end of the modeling unit 212 and adjusting a lowering amount. As will be described later, the additive manufacturing powder 1 is a powder having excellent fillability when being leveled. Therefore, the powder layer 31 having a high filling ratio can be obtained.

The rotation speed of the squeegee roller 24 is set to 0 rpm or more and 50 rpm or less, and the moving speed of the squeegee roller 24 is set to 1 mm/s or more and 25 mm/s or less. By using the metal powder having the characteristics described above as the additive manufacturing powder 1 and setting the rotation speed and the moving speed of the squeegee roller 24 within the above range, the powder layer 31 to be formed can be sufficiently densified. As a result, the powder shaped article 6 formed in the particle bonding step S104 described later can be highly densified and homogenized.

When the rotation speed of the squeegee roller 24 exceeds the upper limit value, the additive manufacturing powder 1 falls from a higher position when the additive manufacturing powder 1 is separated from the squeegee roller 24 after being crushed by the rotating squeegee roller 24. Therefore, the density of the powder layer 31 to be formed tends to vary, and the homogeneity of the density and the thickness of the powder layer 31 decreases.

The rotation speed of the squeegee roller 24 is preferably 0 rpm or more and 40 rpm or less, and more preferably 0 rpm or more and 20 rpm or less.

When the moving speed of the squeegee roller 24 is less than the lower limit value, the formation efficiency of the powder layer 31 decreases. However, when the moving speed of the squeegee roller 24 exceeds the upper limit value, the squeegee roller 24 tends to ride over the accumulated additive manufacturing powder 1. Therefore, the leveling effect of the additive manufacturing powder 1 by the squeegee roller 24 decreases. Accordingly, the uniformity of the density and thickness of the powder layer 31 decreases.

The moving speed of the squeegee roller 24 is preferably 5 mm/s or more and 25 mm/s or less, and more preferably 10 mm/s or more and 20 mm/s or less.

The outer diameter of the squeegee roller 24 is not particularly limited, but is preferably 10 mm or more and 100 mm or less, and more preferably 20 mm or more and 80 mm or less.

In the formation of the powder layer 31, in addition to the additive manufacturing powder 1, other powders may be used in combination. This further increases the density of the powder layer 31. Examples of the other powder include ceramic powder. Examples of the constituent materials of the ceramic powders include oxide-based ceramics such as aluminum oxide, magnesium oxide, titanium oxide, zirconium oxide, silicon oxide, iron oxide, potassium oxide, sodium oxide, calcium oxide, chromium oxide, and niobium oxide, nitride-based ceramics such as boron nitride and silicon nitride, and silicon carbide, and one or two or more types among these are used.

Subsequently, as illustrated in FIG. 3, the squeegee roller 24 is moved in the X-axis direction while compressing the powder layer 31 in a thickness direction by the squeegee roller 24. Accordingly, a filling ratio of the additive manufacturing powder 1 in the powder layer 31 can be increased. The compression by the squeegee roller 24 may be performed as necessary, and may be omitted. The powder layer 31 may be compressed by a unit different from the squeegee roller 24, such as a pressing plate.

### 1.1.3. Particle Bonding Step

The particle bonding step S104 includes the binder solution supplying step S112 and the sintering step S114.

### 1.1.3.1. Binder Solution Supplying Step

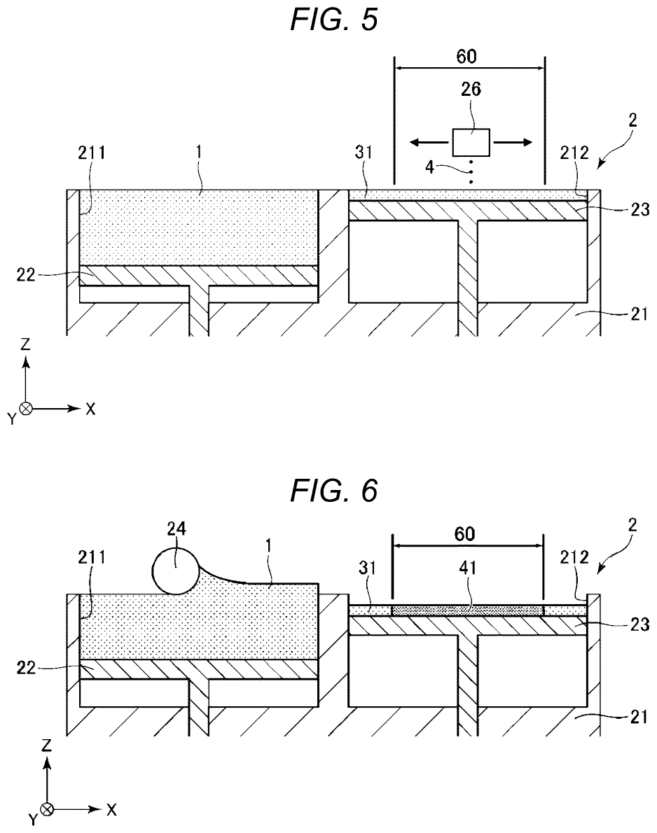

In the binder solution supplying step S112, as illustrated in FIG. 5, the liquid supply unit 26 supplies the binder solution 4 to a forming region 60 corresponding to the powder shaped article 6 to be shaped in the powder layer 31. The binder solution 4 contains a binder and a solvent. In the forming region 60 to which the binder solution 4 is supplied, particles of the additive manufacturing powder 1 are bound to each other, and the binder layer 41 illustrated in FIG. 6 is obtained. In the binder layer 41, the particles of the additive manufacturing powder 1 are bound to each other by the binder, and the additive manufacturing powder 1 has a shape retention property that is not broken due to its own weight.

The binder layer 41 may be heated simultaneously with or after the supply of the binder solution 4. Accordingly, volatilization of a solvent or a dispersion medium contained in the binder solution 4 is promoted, and solidification or curing of the binder promotes binding of the particles to each other. When the binder contains a photo-curable resin or a UV-curable resin, light irradiation or UV irradiation may be performed instead of heating or together with heating.

A heating temperature during heating is not particularly limited, and is preferably 50° C. or higher and 250° C. or lower, and more preferably 70° C. or higher and 200° C. or lower. Accordingly, a sufficient amount of heat can be applied to the binder layer 41, and the volatilization of the solvent or the dispersion medium can sufficiently be promoted.

The binder solution 4 may contain another solvent together with solvent. Examples of the solvent include alcohols, ketones, and carboxylic acid esters, and at least one of the above is used. Examples of the binder contained in the binder solution 4 include fatty acids, paraffin waxes, microcrystalline waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins.

In particular, a solution containing polyvinyl alcohol (PVA), polyvinyl pyrrolidone (PVP), and water is preferably used as the binder solution 4. Accordingly, the binder solution 4 has an appropriate affinity and viscosity for the additive manufacturing powder 1, and also has a good binding property. Therefore, the binder solution 4 contributes to manufacture of the powder shaped article 6 having particularly good density and surface accuracy.

A concentration of the binder in the binder solution 4 is preferably 0.1 mass % or more and 20.0 mass % or less, more preferably 1.0 mass % or more and 15.0 mass % or less, and further preferably 5.0 mass % or more and 12.0 mass % or less. Accordingly, the viscosity of the binder solution 4 is optimized, and a sufficient binding force of the particles of the additive manufacturing powder 1 to each other can be ensured.

The binder solution 4 may contain an additive in addition to the above components. Examples of the additive include a surfactant, a stabilizer, a viscosity increasing agent, a defoaming agent, and a humectant.

A total content of the additive in the binder solution 4 is preferably 20.0 mass % or less, and more preferably 1.0 mass % or more and 15.0 mass % or less.

When it is necessary to stack a plurality of the binder layers 41, the powder layer forming step S102 and the binder solution supplying step S112 are repeated once or more until the predetermined shape is obtained. That is, these steps are performed 2 or more times in total. Therefore, a three-dimensional powder shaped article 6, as illustrated in FIG. 10, can be formed without using a support structure.

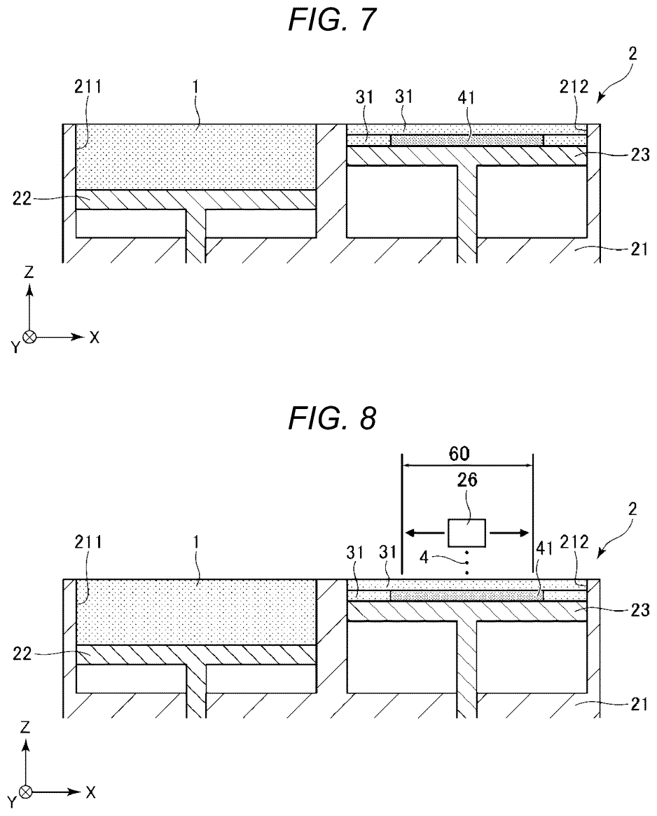

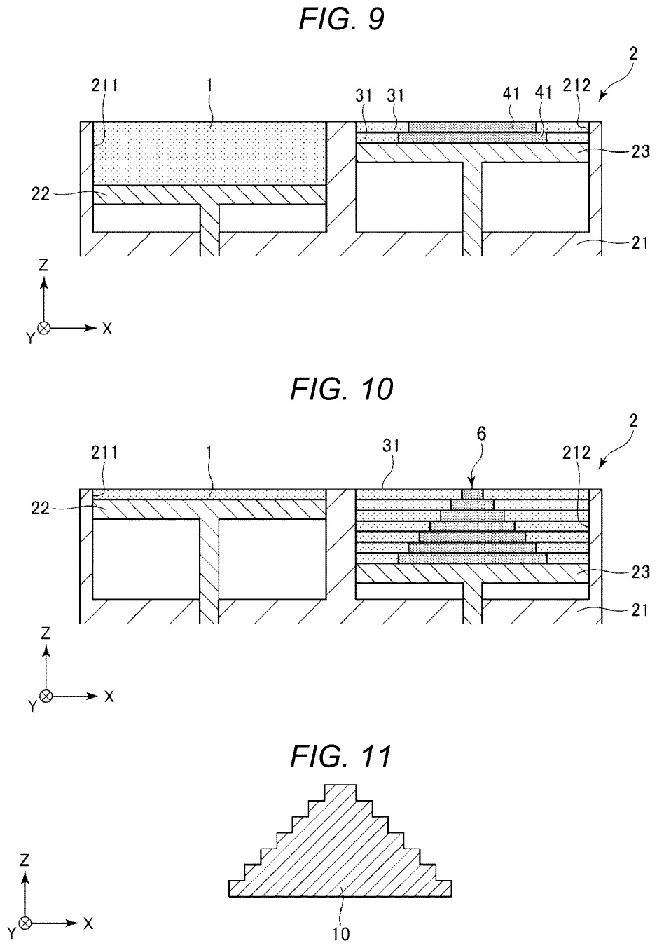

Specifically, as illustrated in FIG. 7, a new powder layer 31 is formed at the binder layer 41. Next, as illustrated in FIG. 8, the binder solution 4 is supplied to the forming region 60 in the newly formed powder layer 31. Accordingly, the binder layer 41 as a second layer illustrated in FIG. 9 is obtained. By repeating these operations, the three-dimensional powder shaped article 6 can be formed.

In the powder layer 31, the additive manufacturing powder 1 that does not constitute the binder layers 41 is collected and reused as necessary, that is, used again for forming the powder shaped article 6.

### 1.1.3.2. Sintering Step

In the sintering step S114, the powder shaped article 6 illustrated in FIG. 10 is obtained by taking out the binder layer 41 from the powder layer 31. Next, the powder shaped article 6 is subjected to a sintering treatment to obtain the metal shaped article 10 illustrated in FIG. 11. In the sintering treatment, the powder shaped article 6 is heated to cause a sintering reaction.

A sintering temperature varies depending on a constituent material, a particle diameter, and the like of the additive manufacturing powder 1, and as an example, is preferably 980° C. or higher and 1330° C. or lower, and more preferably 1050° C. or higher and 1260° C. or lower. A sintering time is preferably 0.2 hours or longer and 7 hours or shorter, and more preferably 1 hour or longer and 6 hours or shorter.

An atmosphere in the sintering treatment is, for example, a reducing atmosphere such as hydrogen, an inert atmosphere such as nitrogen or argon, or a reduced-pressure atmosphere obtained by reducing a pressure of such an atmosphere. The pressure in the reduced-pressure atmosphere is not particularly limited as long as the pressure is lower than a normal pressure (100 kPa), and is preferably 10 kPa or less, and more preferably 1 kPa or less.

When the sintering treatment performed under the above-described conditions is referred to as “main sintering”, “pre-sintering” or “debindering” corresponding to a pretreatment of the main sintering may be performed on the powder shaped article 6 as necessary. Accordingly, at least a part of the binder contained in the powder shaped article 6 can be removed, or a sintering reaction can be caused in a portion. Accordingly, when the main sintering is performed, unintended deformation or the like can be prevented.

A temperature in the pre-sintering or the debindering is not particularly limited as long as the temperature is a temperature at which sintering of a metal powder is not completed, and is preferably 100° C. or higher and 500° C. or lower, and more preferably 150° C. or higher and 300° C. or lower. A duration of the pre-sintering or the debindering in the temperature range described above is preferably 5 minutes or longer, more preferably 10 minutes or longer and 120 minutes or shorter, and still more preferably 20 minutes or longer and 60 minutes or shorter. An atmosphere in the pre-sintering or the debindering is, for example, an ambient atmosphere, an inert atmosphere such as nitrogen or argon, or a reduced-pressure atmosphere obtained by reducing a pressure of such an atmosphere.

The metal shaped article 10 obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, a component for a timepiece, a metal utensil, and a decorative item such as jewelry or an eyeglass frame. 1.1.4. Characteristics of Powder Shaped Article and Metal Shaped Article

From the viewpoint of shape accuracy, the powder shaped article 6 and the metal shaped article 10 described above preferably satisfy the following characteristics.

First, in the binder solution supplying step S112, the powder shaped article 6 with a rectangular parallelepiped shape having a length of 35 mm, a width of 25 mm, and a thickness of 2 mm is formed.

Next, in the sintering step S114, the powder shaped article 6 is subjected to the sintering treatment to obtain the metal shaped article 10.

Next, the length, width, and thickness of the metal shaped article 10 are measured. Subsequently, the shrinkage ratio of the length of the metal shaped article 10 with respect to the length of the powder shaped article 6 is calculated. Similarly, the shrinkage ratio of the width and the shrinkage ratio of the thickness of the metal shaped article 10 are calculated.

In the method for manufacturing the metal shaped article according to the present embodiment, it is preferable that the shrinkage ratio αL of the length, the shrinkage ratio αW of the width, and the shrinkage ratio at of the thickness calculated as described above are all 20% or less.

The average value of the shrinkage ratio αL of the length and the shrinkage ratio αW of the width is defined as ALW. At this time, the ratio ALW/αt of the average value ALW to the shrinkage ratio αt of the thickness is preferably 0.85 or more and 1.00 or less.

By ensuring that the ratio αLW/at falls within this range, a manufacturing method in which the shrinkage ratio is low and isotropic shrinkage occurs can be realized. As a result, a manufacturing method capable of manufacturing a metal shaped article 10 having high dimensional accuracy and homogeneity can be realized.

### 1.2. Additive Manufacturing Powder

Next, the additive manufacturing powder 1 will be described.

### 1.2.1. Constituent Material

The additive manufacturing powder 1 contains an Fe-based metal material. The Fe-based metal material refers to a metal material having an Fe content of more than 50% in terms of an atomic ratio. By using the Fe-based metal material, the powder shaped article 6 having a high Fe content can be obtained. The powder shaped article 6 becomes a metal shaped article 10 having excellent mechanical strength and corrosion resistance derived from Fe, for example, by being sintered.

Examples of the Fe-based metal material include stainless steel such as austenitic stainless steel, ferritic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe—Ni alloy, and an Fe—Ni—Co alloy.

Among these, stainless steel is preferably used as the Fe-based metal material. Stainless steel is a steel type having excellent mechanical strength and corrosion resistance. Therefore, by using the additive manufacturing powder 1 made of stainless steel, the metal shaped article 10 having excellent mechanical strength and corrosion resistance and having high shape accuracy can be efficiently manufactured.

Among the types of stainless steel, precipitation-hardening stainless steel is particularly preferably used. The precipitation-hardening stainless steel has excellent mechanical strength and toughness due to formation of a precipitate.

Examples of the austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS430LX, SUS430J1L, SUS434, SUS436L, SUS436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of the precipitation-hardening stainless steel include SUS630 (17-4PH) and SUS631 (17-7PH).

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The additive manufacturing powder 1 may be provided with a coating film that covers a surface of a core particle made of the Fe-based metal material. The coating film is provided, for example, for a purpose of enhancing flowability and fillability of the additive manufacturing powder 1, and enhancing affinity between the additive manufacturing powder 1 and the binder. Examples of a constituent material of the coating film include organic materials such as resins, inorganic materials such as ceramics and glass, and compounds derived from a coupling agent.

### 1.2.2. Various Characteristics of Additive Manufacturing Powder

Next, various characteristics of the additive manufacturing powder 1 will be described. All of the following characteristics are measured in a state in which the additive manufacturing powder 1 is not provided with the above-described coating film.

### 1.2.2.1. Particle Size Distribution

For the additive manufacturing powder 1 according to the embodiment, when a volume-based particle size distribution is obtained by a laser diffraction type particle size distribution measuring apparatus, a particle diameter when a cumulative frequency is 10% from the small diameter side is defined as D10. Similarly, particle diameters when the cumulative frequency is 50% and 90% from the small diameter side are defined as D50 and D90. An example of the apparatus for measuring the particle size distribution is Microtrac HRA 9320-X100 manufactured by Nikkiso Co., Ltd.

The particle diameter D50 of the additive manufacturing powder 1 is 1.0 μm or more and 10.0 μm or less, preferably 3.0 μm or more and 10.0 μm or less, and more preferably 4.0 μm or more and 9.0 μm or less. Accordingly, both the flowability and the fillability of the additive manufacturing powder 1 can be enhanced. As a result, the dense powder layer 31 can be formed, enabling the obtaining of the dense powder shaped article 6 with high modeling accuracy. Then, the metal shaped article 10 having high density and high surface accuracy can finally be manufactured using the same.

When the particle diameter D50 is smaller than the lower limit value, particles of the additive manufacturing powder 1 tend to agglomerate with each other. Therefore, the flowability and the fillability of the additive manufacturing powder 1 decrease, and the density of the powder layer 31 decreases. However, when the particle diameter D50 exceeds the upper limit value, the gap between the particles of the additive manufacturing powder 1 increases, and the density of the powder layer 31 decreases.

The particle diameter D90 of the additive manufacturing powder 1 is 11.0 μm or more and 25.0 μm or less, preferably 13.0 μm or more and 24.0 μm or less, and more preferably 15.0 μm or more and 23.0 μm or less. Accordingly, both the flowability and the fillability of the additive manufacturing powder 1 can be enhanced. As a result, the dense powder shaped article 6 with high modeling accuracy can be obtained. Then, the metal shaped article having high density and high surface accuracy can finally be manufactured using the same.

When the particle diameter D90 is smaller than the lower limit value, the particle size distribution needs to be narrowed, which increases the manufacturing difficulty of the additive manufacturing powder 1 and leads to higher manufacturing costs. However, when the particle diameter D90 exceeds the upper limit value, the gap between the particles of the additive manufacturing powder 1 increases, and the density of the powder layer 31 decreases.

The ratio D10/D50 of the particle diameter D10 to the particle diameter D50 is preferably 0.30 or more and 0.70 or less, more preferably 0.35 or more and 0.60 or less, and still more preferably 0.40 or more and 0.55 or less. Accordingly, the particle size distribution of the additive manufacturing powder 1 is optimized, and flowability and fillability tend to be enhanced. In addition, the sinterability of the powder shaped article 6 can also be ensured. When the ratio D10/D50 is less than the lower limit value, the particle size distribution is broad, and the flowability may decrease. However, when the ratio D10/D50 exceeds the upper limit value, the particle size distribution is, conversely, excessively narrow, it is difficult to increase the filling ratio, and the sinterability may decrease.

A ratio D90/D50 of the particle diameter D90 to the particle diameter D50 is preferably 1.70 or more and 3.00 or less, more preferably 2.10 or more and 2.90 or less, and still more preferably 2.30 or more and 2.80 or less. Accordingly, the particle size distribution of the additive manufacturing powder 1 is optimized, and flowability and fillability tend to be enhanced. In addition, the sinterability of the powder shaped article 6 can also be ensured. When the ratio D90/D50 is less than the lower limit value, the particle size distribution is narrow, it is difficult to increase the filling ratio, and the sinterability may decrease. However, when the ratio D90/D50 exceeds the upper limit value, the particle size distribution is broad, and the flowability may decrease.

The particle diameter difference D90-D10 between the particle diameter D90 and the particle diameter D10 is preferably 8.0 μm or more and 24.0 μm or less, more preferably 12.0 μm or more and 22.0 μm or less, and further preferably 14.0 μm or more and 20.0 μm or less. Accordingly, the particle size distribution of the additive manufacturing powder 1 is sufficiently narrow, and high flowability can be obtained. As a result, the fillability of the additive manufacturing powder 1 is improved, and the dense powder shaped article 6 having high modeling accuracy can be obtained.

When the particle diameter difference D90-D10 is less than the lower limit value, the particle size distribution of the additive manufacturing powder 1 is extremely narrow, thus it is difficult to increase the filling ratio, and the sinterability may decrease. Therefore, the density and the surface accuracy of the metal shaped article 10 to be manufactured may decrease. However, when the particle diameter difference D90-D10 exceeds the upper limit value, the particle size distribution of the additive manufacturing powder 1 is broad, and the flowability may decrease. Therefore, the density and the surface accuracy of the metal shaped article 10 to be manufactured may decrease. 1.2.2.2. Specific Surface Area

The specific surface area of the additive manufacturing powder 1 is 0.30 m²/g or less, preferably 0.10 [m²/g] or more and 0.25 [m²/g] or less, and more preferably 0.15 [m²/g] or more and 0.22 [m²/g] or less. When the specific surface area is within the above range, the flowability and fillability of the additive manufacturing powder 1 are enhanced, and the dense powder layer 31 can be obtained. Accordingly, the dense powder shaped article 6 with high modeling accuracy is obtained. In addition, the sinterability of the powder shaped article 6 can also be ensured.

When the specific surface area is less than the lower limit value, the manufacturing difficulty of the additive manufacturing powder 1 may increase. However, when the specific surface area exceeds the upper limit value, the flowability and fillability of the additive manufacturing powder 1 decrease.

The specific surface area of the additive manufacturing powder 1 is obtained using a BET method. As a specific surface area measuring apparatus, for example, a BET type specific surface area measuring apparatus HM1201-010 manufactured by Mountech Co., Ltd. may be used, and a specimen amount is 5 g.

### 1.2.2.3. Average Circularity

The average circularity of the additive manufacturing powder 1 is 0.80 or more and less than 1.00, preferably 0.82 or more and 0.95 or less, and more preferably 0.84 or more and 0.92 or less. Accordingly, even when the particle diameter of the additive manufacturing powder 1 is small, the particles tend to roll, and the filling state tends to approach a close-packed state. As a result, the flowability and the fillability of the additive manufacturing powder 1 can be enhanced. In addition, since the surface energy is optimized, the metal shaped article having high density and high surface accuracy can finally be manufactured.

When the average circularity is less than the lower limit, the flowability and the filling ratio of the additive manufacturing powder 1 decrease. However, when the average circularity exceeds the upper limit value, manufacturing difficulty increases, and manufacturing efficiency of the additive manufacturing powder 1 decreases.

The average circularity of the additive manufacturing powder 1 is measured as follows.

First, an image (secondary electron image) of the additive manufacturing powder 1 is taken using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired to obtain images of a total of 300 or more particles.

Next, the circularity of 300 or more particle images is calculated using software. When a circularity is represented by e, an area of a particle image is represented by S, and a perimeter of the particle image is represented by L, the circularity e is determined using the following formula.

$$e = 4 π S / {L}^{2}$$

Next, an average value of the calculated circularities is obtained. The obtained average value is the average circularity of the additive manufacturing powder 1.

### 1.2.2.4. Apparent Density and Tapped Density

An apparent density of the additive manufacturing powder 1 is preferably 2.50 g/cm³ or more and 3.50 g/cm³ or less, more preferably 2.70 g/cm³ or more and 3.40 g/cm³ or less, and still more preferably 2.90 g/cm³ or more and 3.30 g/cm³ or less. When the apparent density is within the above range, favorable fillability can be ensured even in a natural state. Accordingly, when the powder layer 31 is formed using the additive manufacturing powder 1, the powder layer 31 having a high filling ratio can be formed. As a result, the dense powder shaped article 6 with high modeling accuracy can be obtained.

The apparent density of the additive manufacturing powder 1 is measured according to a metal powder apparent density measurement method specified in JIS Z 2504:2012. In addition, for the measurement of the apparent density, a powder characteristic evaluation apparatus, Powder Tester (registered trademark) PT-X manufactured by Hosokawa Micron Corporation is preferably used. Before the apparent density is measured, the additive manufacturing powder 1 to be measured is preferably left to stand in an environment at a temperature of 25° C. and a relative humidity of 50% for 1 hour or longer.

A tapped density of the additive manufacturing powder 1 is preferably 4.20 g/cm³ or more and 4.90 g/cm³ or less, more preferably 4.30 g/cm³ or more and 4.80 g/cm³ or less, and still more preferably 4.40 g/cm³ or more and 4.70 g/cm³ or less. When the tapped density is within the above range, a high filling ratio can be obtained when the powder layer 31 is leveled by the modeling stage 23 or compressed by the squeegee roller 24. Accordingly, the dense powder shaped article 6 with high modeling accuracy can be obtained.

The tapped density of the additive manufacturing powder 1 is measured by a powder characteristic evaluation apparatus, Powder Tester (registered trademark) PT-X manufactured by Hosokawa Micron Corporation. Before the tapped density is measured, the additive manufacturing powder 1 to be measured is preferably left to stand in an environment at a temperature of 25° C. and a relative humidity of 50% for 1 hour or longer.

A ratio of the tapped density to the apparent density of the additive manufacturing powder 1 is preferably 1.20 or more and 1.75 or less, more preferably 1.30 or more and 1.70 or less, and still more preferably 1.40 or more and 1.60 or less. When the ratio is within the above range, a difference in the filling ratio between the additive manufacturing powder 1 in a natural state and the additive manufacturing powder 1 after vibration, load, or the like is applied can be reduced. Therefore, the flowability and fillability of the additive manufacturing powder 1 can be enhanced, while deformation or the like of the powder layer 31 and the powder shaped article 6 caused by differences in the filling ratio can be suppressed.

Although the ratio may be less than the lower limit value, difficulty in stably manufacturing the additive manufacturing powder 1 may increase. However, when the ratio exceeds the upper limit value, the difference in the filling ratio is large, which may cause deformation or the like of the powder shaped article 6.

### 1.3. Method for Manufacturing Additive Manufacturing Powder

Next, an example of a method for manufacturing the additive manufacturing powder 1 will be described.

The additive manufacturing powder 1 may be manufactured using any manufacturing method, and is manufactured, for example, using an atomization method. In the atomization method, a molten metal is caused to flow down from a crucible and collide with a fluid such as a liquid or a gas ejected at a high speed. The molten metal colliding with the fluid falls inertially, and therefore, at this time, becomes spherical droplets. As a result, it is possible to manufacture a metal powder having a high average circularity and a relatively small specific surface area despite a relatively small diameter. In addition, since the specific surface area is small, the moisture content can be reduced.

Examples of the atomization method include a water atomization method, a gas atomization method, and a rotary water atomization method, depending on a difference in a type of a cooling medium and a device configuration.

Flow rate of the molten metal varies depending on an apparatus size and the like, and is preferably more than 1.0 [kg/min] and 20.0 [kg/min] or less, and more preferably 2.0 [kg/min] or more and 10.0 [kg/min] or less. Accordingly, it is possible to optimize the amount of molten metal flowing down during a certain time, and thus a metal powder having a narrow particle size distribution and in which each particle is sufficiently spherical can be efficiently manufactured. As a result, it is possible to manufacture a metal powder having a high average circularity and a relatively small specific surface area despite a relatively small diameter. In addition, since the specific surface area is small, the moisture content can be reduced.

A temperature (casting temperature) of the molten metal in the crucible is preferably set, with respect to a melting point Tm [° C.] of the constituent material of the additive manufacturing powder 1, to Tm+100° C. or higher and Tm+350° C. or lower, more preferably Tm+180° C. or higher and Tm+320° C. or lower, and still more preferably Tm+250° C. or higher and Tm+300° C. or lower. Accordingly, it is possible to ensure a time during which the molten metal is present longer than that in the related art when the molten metal is atomized and solidified using various atomization methods. As a result, it is possible to manufacture a metal powder having a small diameter, a high average circularity and a relatively small specific surface area.

In various atomization methods, an outer diameter of a fine stream when the molten metal flows down is not particularly limited, and is preferably 3.0 mm or less, more preferably 0.3 mm or more and 2.0 mm or less, and still more preferably 0.5 mm or more and 1.5 mm or less. Accordingly, the fluid can be easily and uniformly applied to the molten metal, and thus liquid droplets having an appropriate size can be easily and uniformly scattered. As a result, it is possible to manufacture the metal powder having the average particle diameter and the favorable average circularity as described above with a narrow particle size distribution.

Moreover, in the water atomization method, water injected at a high speed is injected in an inverted conical shape, and the molten metal is caused to collide with the vicinity of the apex. Accordingly, the vicinity of a collision point becomes a negative pressure due to a water film, and thus the molten metal becomes finer. In addition, oxidation of the molten metal can be reduced, and spheroidization can be achieved even when the metal powder to be manufactured is fine. Therefore, it is preferable to use a water-atomized powder (powder manufactured by the water atomization method) as the additive manufacturing powder 1.

The negative pressure in the vicinity of the collision point is preferably 10 kPa or more and 150 kPa or less, and more preferably 30 kPa or more and 120 kPa or less. Accordingly, the metal powder in which the particle diameter and the circularity are optimized can be efficiently manufactured. In addition, when the negative pressure is increased within this range, miniaturization and spheroidization tend to be promoted.

Further, the apex angle of the injected water (the angle formed inside the apex of the inverted cone) can further reduce the pressure in the vicinity of the collision point formed by the water film, and can prolong the time until the molten metal flowing down reaches the collision point. Accordingly, even when the metal powder to be manufactured is fine, spheroidization can be sufficiently achieved. The apex angle of the injected water is preferably 3° or more and 150 or less, and more preferably 5° or more and 10° or less. When the apex angle is reduced within this range, miniaturization and spheroidization tend to be promoted.

In addition, the manufactured additive manufacturing powder may be classified as necessary. Examples of classification methods include dry classification such as sieving classification, inertial classification, and centrifugal classification, and wet classification such as sedimentation classification.

Further, the surface treatment may be performed on the particle surface of the manufactured additive manufacturing powder. Examples of the surface treatment include coupling agent treatment.

### 1.4. Metal Shaped Article

Next, the metal shaped article according to an embodiment will be described.

The metal shaped article manufactured by the method for manufacturing the metal shaped article as described above is formed, in the powder layer obtained by leveling the metal powder satisfying predetermined conditions under predetermined conditions, by sintered bodies of the particles to each other, stacked in the stacking direction, and has high density, high dimensional accuracy, and homogeneity. Specifically, the metal shaped article according to the embodiment satisfies the following characteristics.

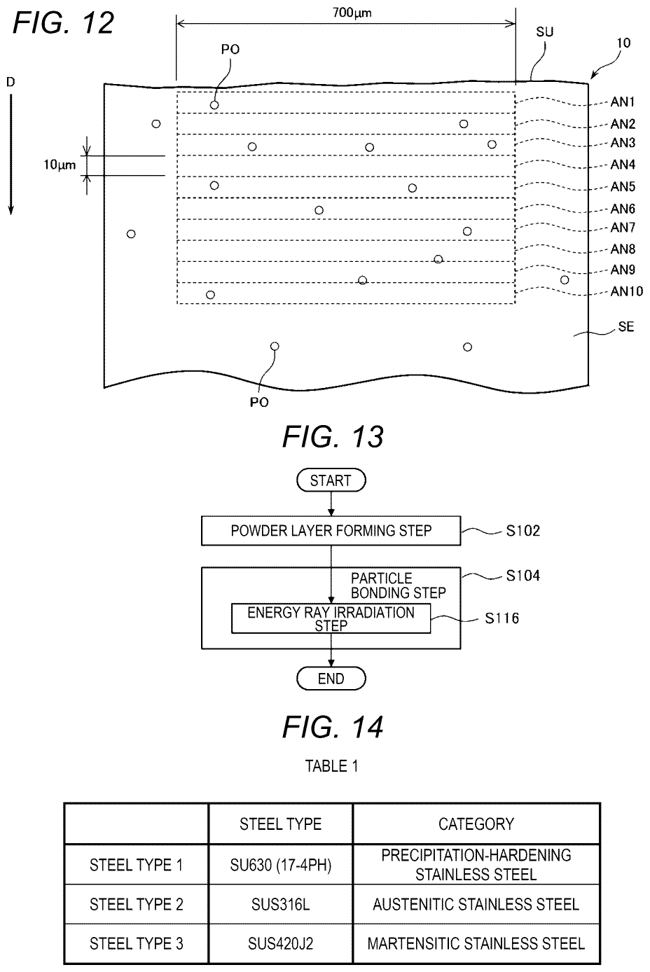

FIG. 12 is a schematic diagram illustrating 10 analysis ranges AN1 to AN10 set in the cross section SE obtained by cutting the metal shaped article 10 according to the embodiment along a plane including the normal to the powder layer 31. In FIG. 12, a cross section SE spreading from the surface SU of the metal shaped article 10 toward the depth direction D is illustrated. In FIG. 12, pores PO inevitably formed in the sintered body occupying most of the region are schematically illustrated.

The analysis range AN1 illustrated in FIG. 12 is a region having a rectangular shape with a width of 10 μm in the extending direction of the normal and a length of 700 μm in the direction orthogonal to the normal set in the cross section SE, and is a region located closest to the surface SU side. The analysis range AN1 is set at a position close to the surface SU. The analysis ranges AN2 to AN10 each have the same size as the analysis range AN1 and are sequentially arranged in the depth direction D from a position adjacent to the analysis range AN1.

Next, the occupied area of the sintered body is calculated in each of the analysis ranges AN1 to AN10. The occupied area ratio is calculated from the calculated occupied area. The occupied area of the sintered body is determined by subtracting the area of the pores PO from each area of the analysis ranges AN1 to AN10. The occupied area ratio of the sintered body is a ratio [%] of the occupied area of the sintered body to the area of the analysis ranges AN1 to AN10.

Next, calculation according to the following calculation formula is performed in analysis ranges adjacent to each other to obtain a calculation result R.

$$Calculation result R = \vert ( ratio of the occupied area of the sintered body in the analysis ranges adjacent to each other ) - 1 \vert$$

In the above description, “ratio of the occupied area of the sintered body in the analysis ranges adjacent to each other” is a ratio obtained by dividing the occupied area of the sintered body in the analysis range closer to the surface SU by the occupied area of the sintered body in the analysis range farther from the surface SU, among the two analysis ranges adjacent to each other. For example, when the calculation result R is obtained for the analysis range AN1 and the analysis range AN2, the calculation result R is a quotient obtained by dividing the occupied area of the sintered body in the analysis range AN1 by the occupied area of the sintered body in the analysis range AN2.

As described above, the occupied area ratios of the sintered body in the analysis ranges AN1 to AN10, and the calculation result R obtained from the analysis ranges AN1 to AN10 can be obtained. The number of data of the occupied area ratio is 10, and the number of data of the calculation result R is 9.

The metal shaped article 10 according to the embodiment satisfies the following two elements (a) and (b).
(a) All of the 10 occupied area ratios are 90.0% or more
(b) The average value of the 9 calculation results R is 0.050 or less

The metal shaped article 10 satisfying the above characteristics has high density and dimensional accuracy and is homogeneous.

In particular, element (a) indicates that the occupied area ratio of the pores PO is sufficiently low and the density is high in all of the analysis ranges AN1 to AN10 set in the cross section SE. Since the cross section SE reflects the cross section of the powder shaped body obtained by stacking the powder layers 31 before the metal shaped article 10 is sintered, element (a) can be considered a characteristic reflecting that the powder shaped body has a high density.

The numerical range of element (a) is preferably 91.0% or more.

When at least one of the occupied area ratios is less than the lower limit of the numerical range of element (a), the density of the metal shaped article 10 decreases. Therefore, this may lead to a decrease in the mechanical strength of the metal shaped article 10.

In addition, element (b) indicates that the difference in the occupied area of the sintered body in the adjacent analysis ranges is sufficiently small in the entire cross section SE. That is, element (b) indicates that the metal shaped article 10 is homogeneous and the dimensional accuracy is high with little deformation associated with the difference in shrinkage ratio for each analysis range.

The numerical range of element (b) is preferably 0.040 or less, and more preferably 0.030 or less.

When the average value of the calculation results R exceeds the upper limit of the numerical range of element (b), at least one of the dimensional accuracy and the homogeneity of the metal shaped article 10 decreases.

The metal shaped article may be made of a molten material instead of the sintered body.

### 2. Second Embodiment

Next, a method for manufacturing a metal shaped article according to a second embodiment will be described.

FIG. 13 is a process drawing illustrating a method of manufacturing a metal shaped article according to the second embodiment.

The second embodiment will hereinafter be described, and in the following description, differences from the first embodiment will mainly be described, and the descriptions of substantially the same matters will be omitted. In FIG. 13, the same reference numerals are given to substantially the same configurations as those in FIG. 1.

The method for manufacturing a metal shaped article illustrated in FIG. 13 includes a powder bed fusion method, which is a type of additive manufacturing method, and includes a powder layer forming step S102 and a particle bonding step S104. Among these, the particle bonding step S104 includes an energy ray irradiation step S116. In the energy ray irradiation step S116, a predetermined region of the powder layer 31 is irradiated with an energy ray to melt the particles of the additive manufacturing powder 1 (metal powder) with each other to form a molten layer in the predetermined region, and then the molten layer is taken out from the powder layer 31 to obtain the metal shaped article 10. Examples of the energy ray include a laser beam and an electron beam.

According to such a configuration, the metal shaped article 10 made of a homogeneous molten layer having high density and dimensional accuracy can be obtained by utilizing the melting of the particles with each other.

The second embodiment described above can also provide the same effects provided by the first embodiment.

### 3. Effects of Embodiment

As described above, the method for manufacturing a metal shaped article according to the embodiment is a method for manufacturing the metal shaped article 10 by bonding the particles of the additive manufacturing powder 1 (metal powder) contained in the powder layer 31 to each other, and includes a powder layer forming step S102 and a particle bonding step S104.

In the powder layer forming step S102, the powder layer 31 is formed by leveling the additive manufacturing powder 1 having an average circularity of 0.80 or more and less than 1.00, a specific surface area of 0.30 m²/g or less, a particle diameter D50 of 1.0 μm or more and 10.0 μm or less, and a particle diameter D90 of 11.0 μm or more and 25.0 μm or less with a squeegee roller 24. The rotation speed of the squeegee roller 24 is set to 0 rpm or more and 50 rpm or less, and the moving speed of the squeegee roller 24 is set to 1 mm/s or more and 25 mm/s or less. In the particle bonding step S104, the particles in the powder layer 31 are bonded to each other. The particle diameter D50 is a particle diameter when a cumulative frequency is 50% from the small diameter side in a cumulative particle size distribution on a volume basis obtained using a laser diffraction type particle size distribution measuring apparatus. The particle diameter D90 is a particle diameter when a cumulative frequency is 90% from the small diameter side in a cumulative particle size distribution.

According to such a configuration, the homogeneous metal shaped article 10 having high density and dimensional accuracy can be efficiently manufactured.

In the method for manufacturing the metal shaped article according to the embodiment, the particle bonding step S104 preferably includes a binder solution supplying step S112 and a sintering step S114. In the binder solution supplying step S112, droplets of the binder solution 4 are supplied from a liquid supply unit 26 to a predetermined region of the powder layer 31, thereby forming a binder layer 41 in a forming region 60 (the predetermined region). In the sintering step S114, the binder layer 41 is taken out from the powder layer 31 to obtain a powder shaped article 6, and the particles of the additive manufacturing powder 1 (metal powder) contained in the powder shaped article 6 are sintered with each other to obtain the metal shaped article 10.

According to such a configuration, the metal shaped article 10 made of a sintered layer is obtained by utilizing the sintering of the particles with each other.

In the method for manufacturing the metal shaped article according to the embodiment, the powder layer forming step S102 and the binder solution supplying step S112 may be repeated.

According to such a configuration, the three-dimensional powder shaped article 6 can be formed. Therefore, the three-dimensional metal shaped article 10 can be manufactured.

In the method for manufacturing a metal shaped article according to the embodiment, the binder solution 4 preferably contains polyvinyl alcohol (PVA) or polyvinyl pyrrolidone (PVP), and water.

According to such a configuration, since the binder solution 4 has appropriate affinity and viscosity with respect to the additive manufacturing powder 1 and has favorable binding properties, the powder shaped article 6 having particularly favorable density and surface accuracy can be obtained.

In the method for manufacturing the metal shaped article according to the embodiment, when the shape of the powder shaped article 6 is a rectangular parallelepiped shape having a length of 35 mm, a width of 25 mm, and a thickness of 2 mm, the shrinkage ratio αL of the length, the shrinkage ratio αW of the width, and the shrinkage ratio αt of the thickness of the metal shaped article 10 to the powder shaped article 6 are all 20% or less, and the ratio ALW/αt of the average value ALW of the shrinkage ratio αL of the length and the shrinkage ratio αW of the width to the shrinkage ratio αt of the thickness is preferably 0.85 or more and 1.00 or less.

According to such a configuration, it is possible to realize a manufacturing method in which the shrinkage ratio is low and isotropic shrinkage occurs. As a result, a manufacturing method capable of manufacturing a metal shaped article 10 having high dimensional accuracy and homogeneity can be realized.

In the method for manufacturing the metal shaped article according to the embodiment, the particle bonding step S104 may include an energy ray irradiation step S116. In the energy ray irradiation step S116, a predetermined region of the powder layer 31 is irradiated with an energy ray to melt the particles of the additive manufacturing powder 1 (metal powder) with each other to form a molten layer in the predetermined region, and then the molten layer is taken out from the powder layer 31 to obtain the metal shaped article 10.

According to such a configuration, the metal shaped article 10 made of the molten layer is obtained by utilizing the melting of the particles with each other.

In the method for manufacturing the metal shaped article according to the embodiment, the additive manufacturing powder 1 (metal powder) may be a water-atomized powder.

In the water atomization method, water injected at a high speed is injected in an inverted conical shape, and the molten metal is caused to collide with the vicinity of the apex. Accordingly, the vicinity of a collision point becomes a negative pressure due to a water film, and thus the molten metal becomes finer. In addition, oxidation of the molten metal can be reduced, and spheroidization can be achieved even when the additive manufacturing powder 1 to be manufactured is fine. Accordingly, the additive manufacturing powder 1 in which the particle diameter and the circularity are optimized can be efficiently manufactured.

The metal shaped article according to the embodiment is the metal shaped article 10 shaped by stacking the molten material or the sintered body of the particles with each other in the stacking direction in the powder layer 31 containing metal powder. In the cross section SE obtained by cutting the metal shaped article 10 along a plane including the normal to the powder layer 31, a region having a width of 10 μm in the extending direction of the normal and a length of 700 μm in a direction orthogonal to the normal is defined as one analysis range, and a total of 10 analysis ranges AN1 to AN10 are set while shifting the region by 10 μm each in the depth direction D. Further, the occupied area and the occupied area ratio of the molten material or the sintered body are calculated in each of the analysis ranges AN1 to AN10. In addition, a calculation result R is obtained by performing calculation using a calculation formula I (ratio of the occupied area in the analysis ranges adjacent to each other)−1| in the analysis ranges adjacent to each other. At this time, in the metal shaped article 10, the occupied area ratios in the 10 analysis ranges AN1 to AN10 are all 90.0% or more, and the average value of the calculation results R determined from the 10 analysis ranges AN1 to AN10 is 0.050 or less.

According to such a configuration, the homogeneous metal shaped article 10 having high density and dimensional accuracy can be obtained.

Although the method for manufacturing the metal shaped article and the metal shaped article according to the present disclosure have been described above based on the illustrated embodiments, the present disclosure is not limited thereto. For example, the method for manufacturing the metal shaped article according to the present disclosure may include any step added for any purpose to the above embodiments. In addition, the metal shaped article according to the disclosure may be obtained by adding any configuration to the above embodiments.

### EXAMPLES

Next, specific examples of the present disclosure will be described.

### 4. Manufacturing of Additive Manufacturing Powder

An additive manufacturing powder in each of samples No. 1 to No. 25 was prepared using a water atomization method. Various conditions in the water atomization method are as follows.
Outer diameter of molten metal that was allowed to flow down: 3.0 mm
Flow rate of molten metal: 5.0 kg/min
Casting temperature: Tm+270° C.
Negative pressure in the vicinity of the collision point of water: 50-100 kPa
Apex angle of water: 5 to 10°

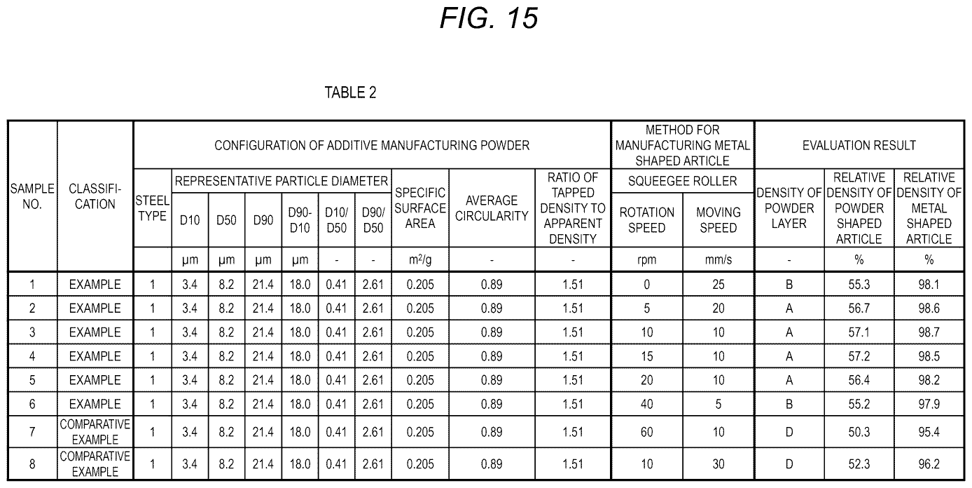

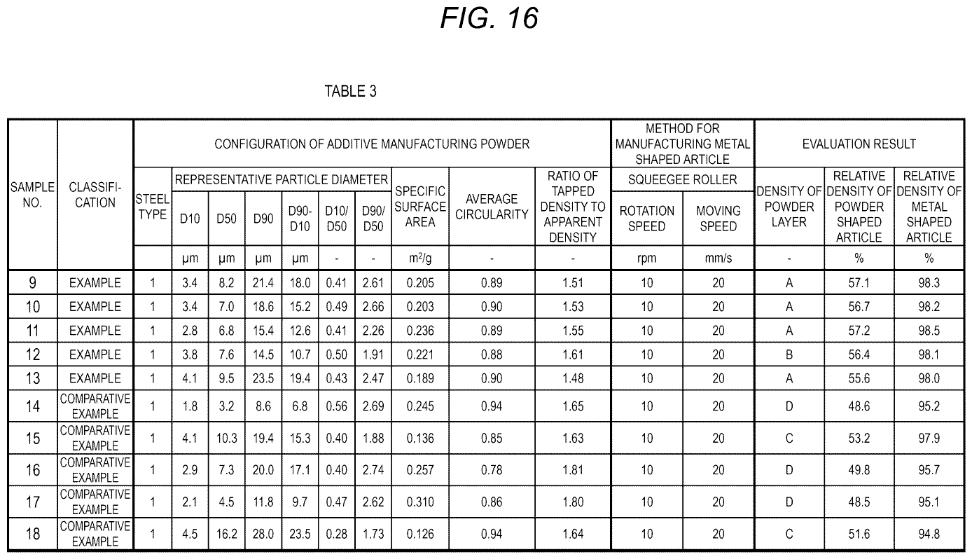

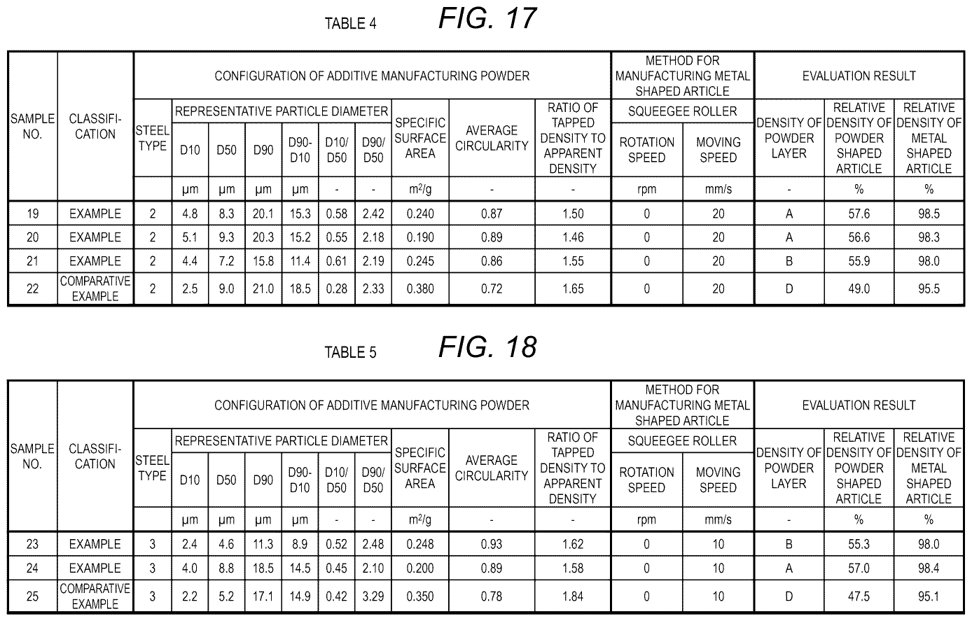

A composition of the additive manufacturing powder in each sample No. is as shown in Table 1 (FIG. 14) to Table 5 (FIG. 18). FIG. 14 is Table 1 showing steel types of the additive manufacturing powders of respective sample Nos. FIG. 15 shows Table 2 indicating the configurations of the additive manufacturing powders, the configurations of the manufacturing methods of the metal shaped articles, and the evaluation results of respective sample Nos. FIG. 16 shows Table 3 indicating the configurations of the additive manufacturing powders, the configurations of the manufacturing methods of the metal shaped articles, and the evaluation results of respective sample Nos. FIG. 17 shows Table 4 indicating the configurations of the additive manufacturing powders, the configurations of the manufacturing methods of the metal shaped articles, and the evaluation results of respective sample Nos. FIG. 18 shows Table 5 indicating the configurations of the additive manufacturing powders, the configurations of the manufacturing methods of the metal shaped articles, and the evaluation results of respective sample Nos.

### 5. Properties of Additive Manufacturing Powder

Table 1 shows steel types used for each additive manufacturing powder.

For each additive manufacturing powder, the representative particle diameter, the specific surface area, the average circularity, and the ratio of tap density to apparent density were respectively measured or calculated. The measurement results and calculation results are shown in Tables 2 to 5.

In Tables 2 to 5, among the manufacturing methods of the metal shaped articles and the additive manufacturing powders of the respective sample Nos., those corresponding to the present disclosure are “Examples”, and those not corresponding to the present disclosure were “Comparative Examples”.

### 6. Evaluation of Method for Manufacturing Metal Shaped Article

### 6.1. Relative Density of Powder Layer

The powder layer was formed by the additive manufacturing apparatus using the additive manufacturing powders and the silica powders of the respective sample Nos. The particle diameter D50 of the silica powders was 10 nm. The addition amount of the silica powder was 0.02 parts by mass with respect to 100 parts by mass of the additive manufacturing powder.

Next, the volume and mass of the obtained powder layer were measured, and the density of the powder layer was calculated. Then, the calculated density was evaluated against the following evaluation criteria. Evaluation results are shown in Tables 2 to 5.
A: The density of the powder layer is 4.30 [g/cm³] or more
B: The density of the powder layer is 4.10 [g/cm³] or more and less than 4.30 [g/cm³]
C: The density of the powder layer is 3.90 [g/cm³] or more and less than 4.10 [g/cm³]
D: The density of the powder layer is less than 3.90 g/cm³

### 6.2. Relative Density of Powder Shaped Article

Using the additive manufacturing powders of the respective sample Nos., a powder shaped article having a rectangular parallelepiped shape was prepared by a binder jet method. The prepared powder shaped article had a length of 35 mm, a width of 25 mm, and a thickness of 2 mm. A PVP aqueous solution was used as the binder solution.

Next, the volume and mass of the prepared powder shaped article and the particle density of the used additive manufacturing powder were measured. A dry automatic density meter capable of measurement by a gas displacement method was used to measure the particle density. Next, the density of the powder shaped article was calculated based on the volume and the mass, and the relative density of the powder shaped article was calculated based on the density and the particle density of the obtained powder shaped article. Calculation results are shown in Tables 2 to 5.

### 6.3. Relative Density of Metal Shaped Article

First, the powder shaped article prepared in 6.2 was subjected to a debindering treatment to remove the binder, and then was sintered in a furnace. A sintering condition in the case of the steel type 1 was 1100° C.×3 hours in an argon atmosphere. Thus, the metal shaped article was obtained. For the steel type 2 and the steel type 3, the sintering condition was selected according to a composition.

Next, the relative density of the metal shaped article was calculated based on the volume and mass of the prepared metal shaped article and the particle density of the used additive manufacturing powder. Calculation results are shown in Tables 2 to 5.

### 6.4. Consideration on Evaluation Results

As shown in Tables 2 to 5, it was confirmed that high-density metal shaped articles can be formed by carrying out the method for manufacturing the metal shaped article of each Example.

### 7. Configuration of Metal Shaped Article

The shrinkage ratio αL of the length, the shrinkage ratio αW of the width, and the shrinkage ratio αt of the thickness were calculated for the metal shaped article manufactured using the additive manufacturing powder of Sample No. 9 and the metal shaped article manufactured using the additive manufacturing powder of Sample No. 16, respectively. The ratio ALW/αt of the average value ALW to the shrinkage ratio αt of the thickness was calculated.

Further, the occupied area ratio of the sintered body in analysis ranges AN1 to AN10 of each metal shaped article, as well as the minimum value thereof, were calculated.

In addition, the calculation result R and its average value, obtained using the above-described calculation formula, were calculated from the analysis ranges adjacent to each other of each metal shaped article that are adjacent to each other.

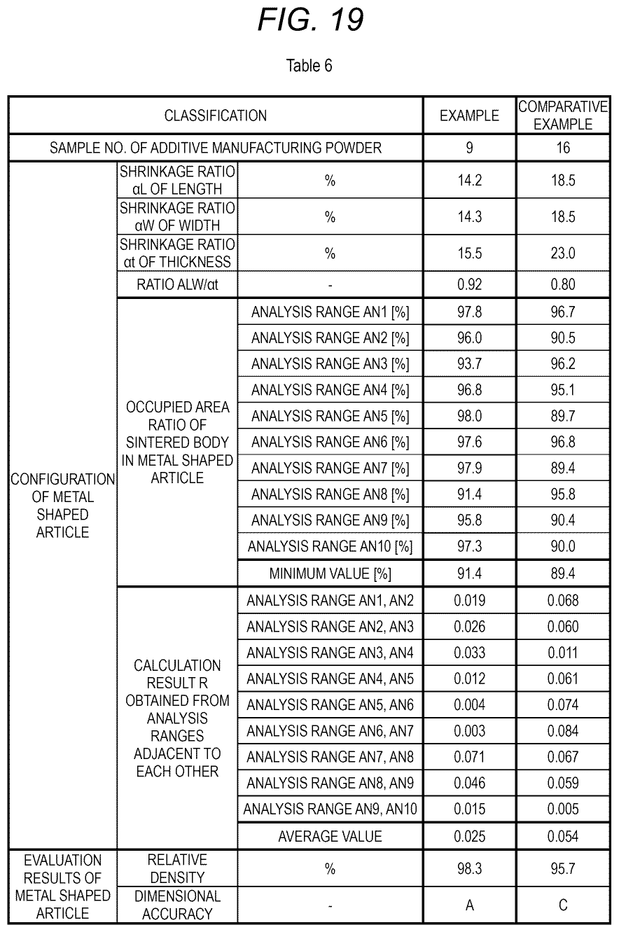

These calculation results are shown in Table 6 (FIG. 19). FIG. 19 shows Table 6 indicating the sample Nos. of additive manufacturing powders used for manufacturing the metal shaped articles, the configurations of the metal shaped articles, and the evaluation results of the metal shaped articles.

In Table 6, the metal shaped article manufactured using the additive manufacturing powder of Sample No. 9 was referred to as “Example”, and the metal shaped article manufactured using the additive manufacturing powder of Sample No. 16 was referred to as “Comparative Example”.

### 8. Evaluation Results of Metal Shaped Articles

The relative density and the dimensional accuracy of the metal shaped articles of Examples and Comparative Examples shown in Table 6 were evaluated. The relative density was measured by the method described above. The dimensional accuracy was evaluated by calculating the ratio of the deviation amount of the metal shaped article to the target value and comparing the ratio with the following evaluation criteria.
A: High dimensional accuracy (deviation from the target value is less than 1%)
B: Slightly high dimensional accuracy (deviation from the target value is 1% or more and less than 2%)
C: Low dimensional accuracy (deviation from the target value is 2% or more)

The metal shaped article of the example shown in Table 6 satisfies both of the above-described elements (a) and (b). That is, in the metal shaped article of the example, the porosity is low in all the analysis ranges, and the variation in porosity between the analysis ranges with each other is small. Therefore, the metal shaped article of the example is homogeneous as compared with the metal shaped article of the comparative example.

In addition, it was confirmed that the metal shaped article of the example has a higher relative density and a higher dimensional accuracy than the metal shaped article of the comparative example.

From the above, it was revealed that the method for manufacturing the metal shaped article according to the present disclosure is capable of manufacturing a homogeneous metal shaped article having high density and dimensional accuracy.

What is claimed is:

1. A method for manufacturing a metal shaped article by bonding particles of metal powder contained in a powder layer to each other, the method comprising:
forming the powder layer by leveling, with a squeegee roller, the metal powder that has an average circularity of 0.80 or more and less than 1.00, a specific surface area of 0.30 m²/g or less, a particle diameter D50, at which the cumulative frequency is 50% from the small diameter side, in a cumulative particle size distribution on a volume basis obtained by using a laser diffraction type particle size distribution measuring apparatus, of 1.0 μm or more and 10.0 μm or less, and a particle diameter D90, at which the cumulative frequency is 90% from the small diameter side, in the cumulative particle size distribution of 11.0 μm or more and 25.0 μm or less; and
bonding the particles of the powder contained in the powder layer to each other;
wherein the rotation speed of the squeegee roller is set to 0 rpm or more and 50 rpm or less, and the moving speed of the squeegee roller is set to 1 mm/s or more and 25 mm/s or less.

2. The method for manufacturing the metal shaped article according to claim 1, wherein the bonding the particles comprises:
supplying a binder solution from a liquid supply unit to a predetermined region of the powder layer to form a binder layer in the predetermined region; and
taking out the binder layer from the powder layer to obtain a powder shaped article, and sintering the particles of the metal powder contained in the powder shaped article with each other to obtain the metal shaped article.

3. The method for manufacturing the metal shaped article according to claim 2, wherein the forming the powder layer and the supplying the binder solution are repeated.

4. The method for manufacturing the metal shaped article according to claim 2, wherein the binder solution contains polyvinyl alcohol (PVA) or polyvinyl pyrrolidone (PVP), and water.

5. The method for manufacturing a metal shaped article according to claim 2, wherein, when the shape of the powder shaped article is a rectangular parallelepiped shape having a length of 35 mm, a width of 25 mm, and a thickness of 2 mm,
the shrinkage ratio of the length, the shrinkage ratio of the width, and the shrinkage ratio of the thickness of the metal shaped article to the powder shaped article are all 20% or less, and
the ratio of the average value of the shrinkage ratio of the length and the shrinkage ratio of the width to the shrinkage ratio of the thickness is preferably 0.85 or more and 1.00 or less.

6. The method for manufacturing the metal shaped article according to claim 1, wherein the bonding the particles comprises irradiating an energy ray to a predetermined region of the powder layer to melt the particles of the metal powder with each other to form a molten layer in the predetermined region, and then taking out the molten layer from the powder layer to obtain the metal shaped article.

7. The method for manufacturing the metal shaped article according to claim 1, wherein the metal powder is a water-atomized powder.

8. A metal shaped article shaped by stacking a molten material or a sintered body of the particles with each other in a stacking direction in a powder layer containing metal powder, wherein
in a cross section obtained by cutting along a plane including the normal to the powder layer,
a region having a width of 10 μm in an extending direction of the normal and a length of 700 μm in a direction orthogonal to the normal is defined as one analysis range,
a total of 10 analysis ranges are set while shifting the region by 10 μm each in a depth direction, an occupied area and an occupied area ratio of the molten material or the sintered body are calculated at each of the analysis ranges, and
calculation is performed by a calculation formula| (ratio of the occupied areas in the analysis ranges adjacent to each other)−1| at the analysis ranges adjacent to each other to obtain calculation results, and when the calculation results are obtained,
the occupied area ratios in the 10 analysis ranges are all 90.0% or more, and an average value of the calculation results determined from the 10 analysis ranges is 0.050 or less.
